(19) United States
(12) Patent Application Publication
(10) Pub. No.: US 2026/0220577 A1
(43) Pub. Date: Jul. 30, 2026

(54) CUSTOMIZABLE PROCESS MINING TEMPLATES

(71) Applicant: SAP SE, Walldorf (DE)

(72) Inventors: Gregor Berg, Berlin (DE); Tatiane dos Santos Carvalho, Berlin (DE); Lars Baumann, Mannheim (DE); Carolin Brucker, Berlin (DE); Johannes Haasen, Trier (DE); Mario Schlereth, Cologne (DE); Matthias Weidlich, Berlin (DE)

(73) Assignee: SAP SE, Walldorf (DE)

(21) Appl. No.: 19/039,694

(22) Filed: Jan. 28, 2025

(51) Int. Cl. G06Q 10/0633; G06F 3/04842

(52) U.S. Cl. CPC G06Q 10/0633; G06F 3/04842

(57) ABSTRACT

Techniques and solutions are provided for configuring a process mining template to include events for particular process mining enhancements. For example, users can select to add events relevant to specific industries or for value drivers. The events are associated with database queries that can be executed to determine occurrences of events. Events for process mining enhancements can be determined by clustering events from one or more existing process mining templates. A sample of an entity's data, in a database, can be processed prior to deploying a process mining template to determine overlap between currently defined events of the client and the events for the process mining enhancements, or to compare an entities metrics to reference values.

### FIELD

The present disclosure generally relates to process mining, particularly techniques for generating customized process mining templates from predefined process mining components.

### BACKGROUND

Enterprise-level software is critical to the operation of modern businesses, and includes complex software systems for performing operations in areas such as enterprise resource planning (ERP), customer relations management, capturing transactional information, or controlling manufacturing processes. While the software may be used in the operation of a business, the software is technically complex and is used to process huge volumes of data. In addition to resources needed to program and maintain the software, significant amounts of computing resources such as processors, memory, and storage, and significant effort can be required to configure software for a particular purpose.

As one example, software can help track processes, including to determine how the entity is operating, which can include tracking various performance measures and comparing them to targets or benchmarks. Significant effort can be required to define computer-processable representations of these processes, and to ensure that they accurately reflect actual operations of an entity.

Process modeling techniques, such as Business Process Model and Notation (BPMN) or Unified Modeling Language (UML), are often used to create graphical representations of an intended process flow. Computer-implemented data structures or other computer implementation artifacts are defined to represent process elements, including activities, events, decisions, participants, and data objects. These data structures are subsequently mapped to database objects, such as tables or views. Manual process definition allows for precise customization and alignment with organizational requirements, but can be resource-intensive and may require ongoing maintenance to accommodate changes in business processes. Further, manual definition can result in some events being generated that do not provide much practical benefit, which can thus cause significant computing resources to be used for insights that may provide little added value. Conversely, manual definition can result in some events that would provide useful insights not being defined. Thus, two entities trying to model and analyze a common, or at least similar process, can have significant differences in the events that are analyzed, and the corresponding insights produced. Accordingly, room for improvement exists.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Techniques and solutions are provided for configuring a process mining template to include events for particular process mining enhancements. For example, users can select to add events relevant to specific industries or for value drivers. The events are associated with database queries that can be executed to determine occurrences of events. Events for process mining enhancements can be determined by clustering events from one or more existing process mining templates. A sample of an entity's data can be processed prior to deploying a process mining template to determine overlap between currently defined events of the client and the events for the process mining enhancements, or to compare an entities performance metrics to reference values.

In one aspect, the present disclosure provides a process of configuring a process mining template that includes events for process mining enhancements. A user interface is displayed. The user interface includes a first user interface element configured to receive a selection of a process to be analyzed using process mining, with a set of events being defined for the process. A second user interface element is displayed. The second user interface element is configured to receive a selection of a process mining enhancement, the process mining enhancement including one or more events to be added to the set of events defined for the process.

First user input of a selected process is received through the first user interface element. Second user input of a selected process mining enhancement is received through the second user interface element. A process mining template is generated. The process mining template includes events defined for the selected process and the selected process mining enhancement.

The present disclosure also includes computing systems and tangible, non-transitory computer readable storage media configured to carry out, or including instructions for carrying out, an above-described method. As described herein, a variety of other features and advantages can be incorporated into the technologies as desired.

### BRIEF DESCRIPTION OF THE DRAWINGS

FIG. 1 is a diagram illustrating a domain model, such as a domain model for use in a process template useable for process mining or process analysis.

FIG. 2 is a diagram illustrating an event domain model for events defined with respect to the domain model of FIG. 1.

FIG. 3 is a diagram of a process that uses events of the event domain model of FIG. 2.

FIG. 4 illustrates an example JSON listing of a portion of a domain model and a portion of an event domain model.

FIGS. 5A and 5B illustrate a portion of an example process template for the process of FIG. 3.

FIG. 6 is a diagram of a process using a domain model and an event domain model, at least a portion of which can be represented in a process template, to extract events from a data store.

FIG. 7 illustrates an example user interface for setting up a process mining project.

FIG. 8 is a diagram illustrating how events can be clustered, clusters can be selected via a user interface, and selected clusters can be used to define model information for process analysis via mining.

FIG. 9 illustrates an example user interface with widgets for presenting process mining information or insights derived therefrom.

FIG. 10 is a flowchart of a process of configuring a process mining template that includes events for process mining enhancements.

FIG. 11 is a diagram of an example computing system in which some described embodiments can be implemented.

FIG. 12 is an example cloud computing environment that can be used in conjunction with the technologies described herein.

### DETAILED DESCRIPTION

### Example 1)—Overview

Continuing from the Background, the present disclosure provides techniques and solutions that allow a user to select a process that is associated with a predefined set of event definitions and insights that can be deployed to analyze process data of an entity. A user configuring a process mining scenario can make selections that add more events to a standard analysis defined for the process. That is, for example, while some events and insights may be of interest for any implementation of a process, other events and insights may only be relevant to a particular industry or use case, or when the user is interested in a particular type of insight.

In some cases, enterprise level software may come with process mining templates (where subsequent use of the term “template” refers to a process mining template). Templates serve as structured frameworks for documenting, standardizing, and analyzing business processes within organizations. At a conceptual level, a process template typically includes elements such as process activities or events, decision points, participants, inputs, outputs, and dependencies. These templates provide a standardized representation of the process flow, enabling stakeholders to understand, communicate, and analyze processes consistently. In addition to process activities and events, templates may also include performance metrics, compliance requirements, and organizational guidelines.

At a technical implementation level, process templates can be implemented in a variety of ways. One common approach is to represent process templates using XML or JSON formats, which allow for flexible and extensible definitions of process elements. For example, an XML-based process template might define activities using tags such as <activity>, <decision>, or <task>, with attributes specifying activity names, descriptions, inputs, outputs, and participants. Event definitions can be included as part of these artifacts, specifying the conditions under which events are detected in process data. Further, such templates can include many different artifacts, which can be packaged and provided as a zipped archive file.

Process templates can be implemented using domain-specific modeling languages or tools tailored to process modeling and analysis, including those that operate using the file-based information discussed above. These tools often provide graphical user interfaces for designing and editing process templates, allowing users to drag-and-drop process elements onto a canvas and define their properties using form-based interfaces. Behind the scenes, the tool generates code or configuration files representing the process template, which can then be deployed and executed within process management systems or workflow engines. Event definitions and queries can be automatically generated and included in these configuration files to facilitate event detection and analysis.

In addition to representing the structure and logic of the process flow, process templates may also include metadata or annotations to capture additional information such as process variants, performance metrics, compliance requirements, or organizational guidelines. This metadata enhances the usability and interpretability of the process templates, enabling more comprehensive analysis and optimization of business processes. Furthermore, predefined templates for various business processes are often mapped to a database schema to facilitate efficient data storage, retrieval, and manipulation within an enterprise software system. This mapping ensures alignment between the process templates and the underlying database structure. For example, within the context of ERP (Enterprise Resource Planning) software, predefined templates for various business processes are often mapped to a database schema to facilitate efficient data storage, retrieval, and manipulation within the relevant computing system, such as an ERP system. As a particular example, event definitions are mapped to specific database tables and fields to enable accurate event detection and data extraction.

As a more specific example, consider a process template (such as including a domain model and an event domain model) expressed in a spreadsheet format, such as using MICROSOFT EXCEL. Within the spreadsheet file, each process template can be organized into separate worksheet tabs. Columns within each worksheet represent different process elements such as activities, decision points, participants, inputs, outputs, dependencies, and metadata. Each column is typically labeled with a header indicating the type of information it contains. Rows within the worksheet correspond to specific steps or tasks within the process, with cells containing details about each process element, such as activity names, descriptions, inputs, outputs, responsible parties, deadlines, and other relevant information. Event definitions can be included in separate tabs or integrated within the relevant process elements to specify the conditions for event detection.

Data validation features can help ensure data integrity and consistency within the template by enforcing predefined guidelines or standards. Moreover, spreadsheet functionality for formulae and functions enables calculations, automation of repetitive tasks, or generation of dynamic content.

In some cases, a spreadsheet file or other process template representation is mapped to specific tables or views in the database schema of the enterprise software system being analyzed. For instance, in a spreadsheet file, each row maps to a record in the database table, with each column representing a field or attribute of the record. Alternatively, an intermediate component, such as data integration tools or process mining software, can import the process model from the spreadsheet file and map it to relevant tables in the database schema. SIGNAVIO, available from SAP SE, is an example of a suitable intermediate component, which can integrate with process templates in various formats and create process template representations that are mapped to a database schema as described above. This intermediate component can perform data transformations, validation, and enrichment to ensure compatibility between the process model and event data. In addition to mapping the process model to the database tables, metadata mapping can be used to establish links between specific elements in the process model (e.g., activity names, IDs) and corresponding data fields in the event logs. Event definitions are also mapped to the relevant database fields to enable accurate event detection and analysis.

The above-described templates can be used to generate a “primary” set of events and insights, where additional templates, or template components, can be included for more specific scenarios, such as use of the process in a particular industry or to look for specific types of insights. The information in these additional templates, or other source of template components, can be added to the “base” template to provide a process analysis that is customized to the needs of a particular entity.

In many cases, an entity, such as a lead-to-cash process analyst of the entity, may want to perform additional customizations of a provided template. For instance, an analysis of the delivery procedures as part of the lead-to-cash process differs in many details between different industries. While, for oil and gas, it is about shipping millions of barrels over an ocean, for renewables, it is about getting the right permits to transport enormous windmill parts across highways for parts of the high-tech industry. However, disclosed techniques provide a starting point for such customizations, rather than requiring both the customizations and the “base” functionality to be developed for each entity and use case. Even if entities customize a common template in different ways, it can be beneficial to maximize overlap between templates, including to aid in comparing results of a process for one entity to results of a process to another entity. Disclosed techniques can also improve the performance of a computer, including because a template can be configured to include events that provide the greatest insights, and omitting other types of events that may consume processing and storage resources while providing little practical value. By focusing on the most relevant events and insights, the templates can optimize data processing and analysis, leading to more efficient and effective process mining.

Categories of events that can be added to a set of base events for a process are referred to as process mining enhancements. Examples of process mining enhancements include industry-specific enhancements, value driver enhancements, country or region-specific enhancements, or enhancements that are corrected to businesses of particular sizes.

A value driver in the context of process mining and business processes refers to a specific factor, metric, or capability that directly influences the overall performance, efficiency, or profitability of a business process. These are elements that, when optimized, contribute significantly to achieving key business objectives such as cost reduction, enhanced customer satisfaction, increased revenue, or compliance assurance. Value drivers are characterized by their measurable impact on process outcomes, their potential for actionable interventions, and their alignment with broader strategic goals.

For example, “reduce cycle time” is a value driver where reducing the time required to complete a process can lead to improved efficiency and customer satisfaction. Similarly, “Reduce Days Sales Outstanding (DSO)” is another value driver in financial processes, where lowering the average collection period can enhance cash flow and overall financial health. Other examples include minimizing process variance to ensure consistency and quality, increasing the first-time right rate to reduce costs and waste by avoiding rework, and improving throughput to boost productivity by handling more transactions or tasks within a given timeframe.

### Example 2)—Example Domain, Event Domain, and Process Template Representations

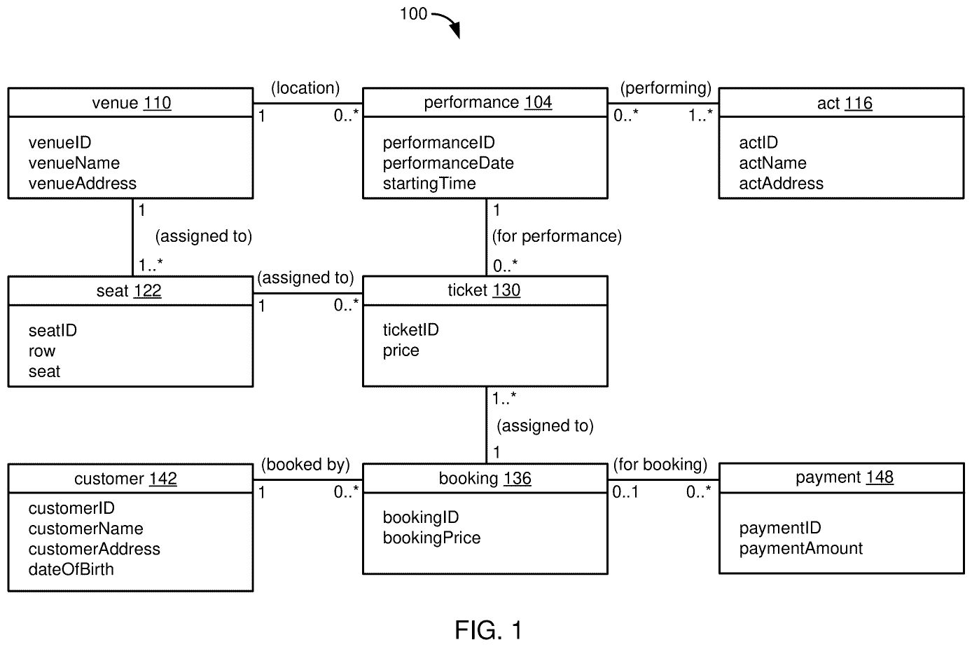

Process mining templates can be informed by other information structures, such as domain models or event domain models, as will be further described. A domain model provides a structured representation of fundamental concepts, entities, and relationships within a specific domain. An example domain model 100 is provided in FIG. 1, and defines entities such as Concert, Venue, Ticket, Customer, and their attributes and relationships. The domain model 100 can be correlated with computing objects that store corresponding data, such as tables or other database objects in a database schema.

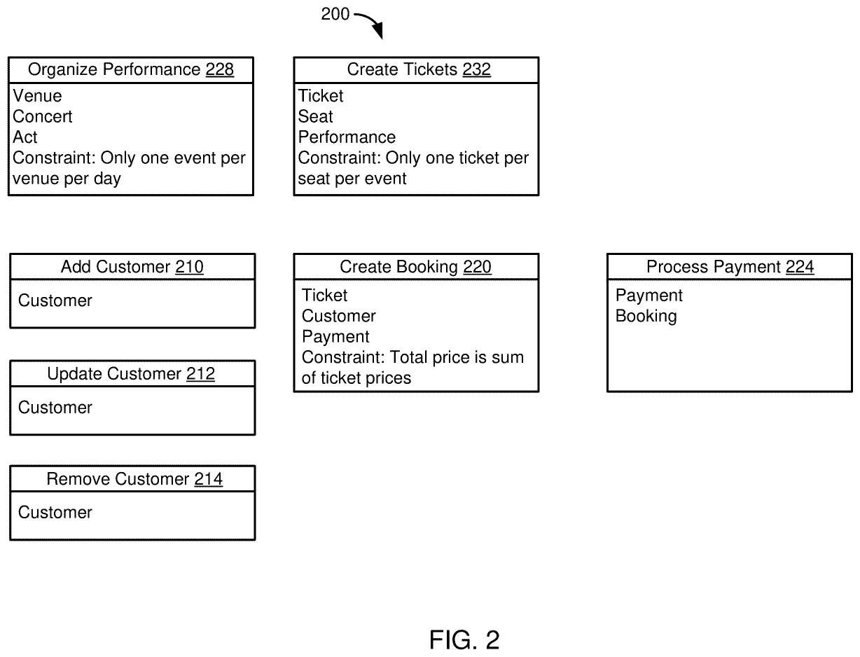

An event domain model, such as the event domain model 200 of FIG. 2, provides a representation of significant events or occurrences within a domain and their relationships to entities and processes. For instance, a domain model can capture events like scheduling a concert or booking a ticket, and their effects on domain entities. An event is considered to have occurred if the conditions defined for it can be observed in the historic data of the underlying system. Not all possible events are of interest for a customer (e.g., how often customers change their addresses) which is why the process analysis usually focusses on a dozen up to not more than 50 to evaluate the different paths the process instances have taken through the process and its implementation in the enterprise system, although the present disclosure does not preclude the use of larger numbers of events.

A process template serves as a standardized framework for capturing and analyzing business processes, such as processes defined based on events of an event domain model and entities in a domain model. It defines process steps, activities, events, roles, and their relationships, facilitating process mining and optimization.

Turning to FIG. 1, the domain model 100 can be used to represent entities involved in processes for booking bands or other types of acts for a performance at a particular venue, and for selling tickets to the performance. For example, booking an act can be represented by a performance 104, where the performance has a date and start time, and is associated with a venue 110 and an act 116. A venue 110 has seats 122, and tickets 130 are issued for specific seats for specific performances 104. A booking 136 includes one or more tickets 130, and is made by a customer 142, who makes a payment 148 for the booking.

It can be seen that each entity in the domain model 100 has a number of attributes. For example, a performance 104 has an identifier, a date, and a time, while seats have a seat identifier, and location information for the seat, such as a row number and a seat number. Again, these attributes can be correlated with data values, such as where a table can store attribute values for performances 104, and another table can store attribute values for seats 122. Depending on implementation, data storage entities may exist for each entity in the domain model 100, or one or more domain model entities can be represented in a single data storage entity (such as a denormalized database table).

Note that entities in the domain model 100 may be subject to constraints, such as where only one performance can be booked at a given venue for a given day, or that two tickets cannot be issued for the same seat at the same performance.

The event domain model 200 of FIG. 2 illustrates events that can occur in a process, and can be specified for entities of the domain model 100. For example, the customer entity 142 can be associated with an event 210 to add a customer, an event 212 to update information associated with the customer (such as attributes of the customer entity), or an event 214 to remove a customer from the system.

Other events can be defined with respect to multiple entities. An event 220 to create a booking 136 can reference one or more tickets 130, a customer 142, and a payment 148. Events can be associated with definitions or constraints, such as where the created booking event 220 is defined such that the total price of the booking is the sum of the ticket prices in the booking. That is, while a constraint may or may not be enforced during the booking process, the constraint can be evaluated after the fact on mined process data. An event 224 corresponds to processing payment for a booking.

An organize performance event 228 and a create ticket event 232 also refer to multiple entities, and are subject to constraints.

As will be further explained, the event domain model 200 can be useful in understanding a process/process elements at more conceptual level, such as for use by business analysts, but are typically linked to computer artifacts or code to perform actions such as identifying occurrences of events. As used herein, a computing implementation artifact refers to any technical construct, such as schema definitions, database tables, objects in virtual data models, code modules, or configurations, designed and used within computer systems to represent, store, process, or manipulate data, processes, or models. These artifacts are created and manipulated within the realm of computer programming and are integral components of software systems, serving as machine-readable representations of various conceptual entities, models, or operations. Unlike mental or manual representations, computing implementation artifacts are tailored for computer processing and are optimized for efficiency, scalability, and interoperability within software environments

As a simple example, the event 210 to add a customer can be associated with a query such as:

SELECT
EventType,
EventTimestamp,
(SELECT COUNT(*) FROM ChangeLogTable WHERE
TableName =
‘CustomerTable’ AND Operation = ‘INSERT’) AS
TotalEventOccurrences
FROM
ChangeLogTable
WHERE
TableName = ‘CustomerTable’
AND Operation =‘'INSERT’;

The query returns records for each occurrence of the event, in the form of the event type and the event timestamp, and also returns the number of times the event occurred in the dataset. Additional queries to determine, e.g., the average age of all customers or which acts 116 are mostly booked by customers aged below 30 can be constructed the same way.

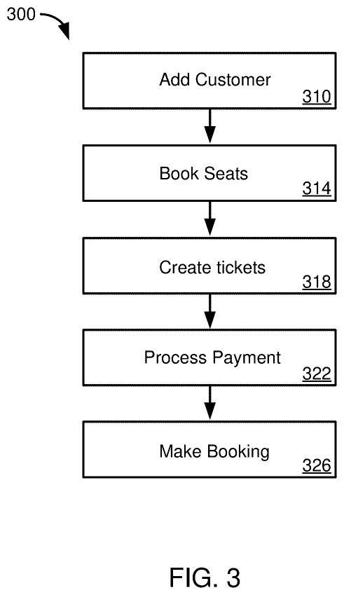

FIG. 3 illustrates an example process 300 of making a booking. The process of making a booking can use a subset of the events in the event domain model 200. In turn, the events of the event domain model 200 can be associated with particular entities and entity attributes in the domain model 100. The example process 300 can occur after an organizer contracts act for a performance at a particular venue.

At 310, a customer can be added, such as using input (attribute values) provided by the customer. That is, the event 310 for of the process 300 will be detected based on particular process data processed during processed mining. For example, an insertion of a row for a customer table can indicate the addition of a customer at 310. The customer can select particular seats, which are booked at 314. Booking can include updating a status of the seats to “occupied” or a similar designation. Again, the event 314 can be detected from process data, such as by an update to records for particular seats, associating them with a status change or assigning them to a particular booking. Tickets can be created for the booking at 318, including being associated with the respective seats, which can be reflected in process data through new records being added to a table representing tickets. Once all of the seats have been selected and tickets generated, a customer payment is processed at 322, which can be reflected in the process data as a new payment record. The booking is completed at 326, which can include persisting data changes made as a result of the process 300, such as making seats as “occupied” or “sold,”, which again can be reflected in process data such as an update to records for the seats.

Again, a definition of the process 300 can be linked to computer functionality to identify occurrences of the process in a dataset, which can include looking at particular details of such occurrences, including in generating performance metrics. Continuing with the example, the following query returns process identifiers (that is, each event for a specific booking request includes the process identifier, identifying the events as part of the same transaction/instance) of processes that correspond to instances of the process 300, along with the total number of times the event was observed in the dataset.

SELECT Process_ID, COUNT(Process_ID) AS Total_
Occurrences
FROM (
SELECT DISTINCT process_id
FROM event_log
WHERE event_type = ‘add_customer’ AND process_id IN (
SELECT DISTINCT process_id
FROM event_log
WHERE event_type = ‘book_seats’ AND process_id IN (
SELECT DISTINCT process_id
FROM event_log
WHERE event_type = ‘create_tickets’ AND process_id IN (
SELECT DISTINCT process_id
FROM event_log
WHERE event_type = ‘process_payment’ AND
process_id IN (
SELECT DISTINCT process_id
FROM event_log
WHERE event_type = ‘make_booking’
)
)
)
)
) AS Subquery
GROUP BY Process_ID;

A number of metrics can be defined for the process 300, and can allow an organization to evaluate how the process is being performed, and in at least some cases compare their performance with particular peers or peer groups. Performance metrics that can be used in the process 300 include, a Booking Time, the time to complete the booking process, from initiating the process 300 through the operation to complete the booking at 326. Typically, queries in this example revolve around the performance as the driving domain object in the analysis, to understand the lifecycle of a performance, its bottlenecks and ultimately derive ideas for improving how performances can be organized to greater success.

As an example, the following query can calculate booking time for process identifiers determined to have followed the process 300:

SELECT Process_ID,
MIN(Timestamp) AS Start_Time,
MAX(Timestamp) AS End_Time,
TIMESTAMPDIFF(SECOND, MIN(Timestamp),
MAX(Timestamp)) AS
Total_Time_Seconds
FROM event_log
WHERE Process_ID IN (SELECT DISTINCT Process_
ID FROM
earlier_query_result)
GROUP BY Process_ID;

The query again illustrates that, although the domain model 100, the event domain model 200, and the process 300 can be defined and presented in a form more readily understood by organizations, and can be displayed graphically to users, they are also associated with computing implementation artifacts, including computer implementation artifacts that allow for storing data associated with entities of the domain model, events of the event domain model, and particular processes associated with a template, including particular performance metrics for such processes. A tuple that includes a domain model, an event model, and a resulting template can be designed for specific enterprise software and a specific process to be analyzed.

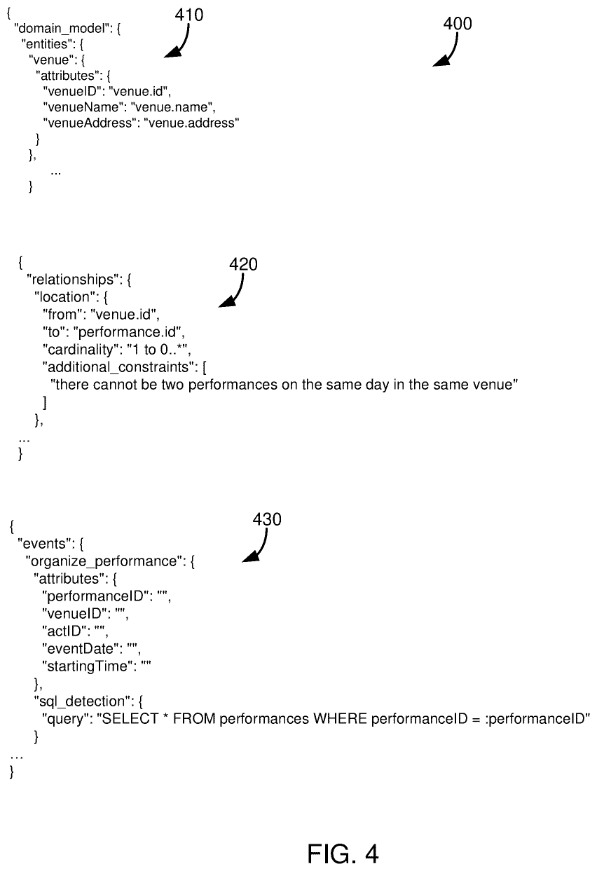

These domains, event domains, processes, and process template representations can be defined in computer implementation artifacts in various formats, including using XML or JSON. FIG. 4. 4 provides an example JSON listing 400 that provides representative portions of a domain model and an event domain model corresponding to the domain model 100 of FIG. 1 and the domain event model 200 of FIG. 2. Code 410 defines entities of the domain model 100, and their attributes. These attributes correspond to attributes of database artifacts, such as tables, that are processed to extract information about instances of the entities and events associated with such entities. The attributes can be mapped to particular tables that log information about data updates, for example, the CDPOS and CDHDR tables of system of SAP SE, of Walldorf Germany.

Data for particular entity instances can be stored by providing values for the keys represented in the code 410. The code 410 provides definitions of entities, but that actual data is stored elsewhere, such as in database tables that are operationally linked with the entities of the code 410.

FIG. 4 also includes code 420 that defines relationships between the entities of the code 410, as well as any constraints on the entities/their relationships. FIG. 4 includes code 430 that defines various events that can occur with the entities of the code 410, such as corresponding to events of the event domain model 200. Note that the code 430 can include events for multiple processes, and in this respect can differ from a process template. That is, a process template is typically defined for a specific process, which may involve multiple events, but typically less than all of the events of the event domain model 200. Processes can include other processes, such as including them as subprocesses. For example, the event domain model 200 can include an add customer process, but the add customer process can be a subprocess of a “make booking” process. Along with the definitions of the events, the code 430 provides SQL statements that can be executed to detect events in process data. However, in some cases, such as when clustering events, as will be further described, it can be useful to include all possible events in a single template, and then portions of that template can be extracted into event clusters, and the event clusters used to create a customized template.

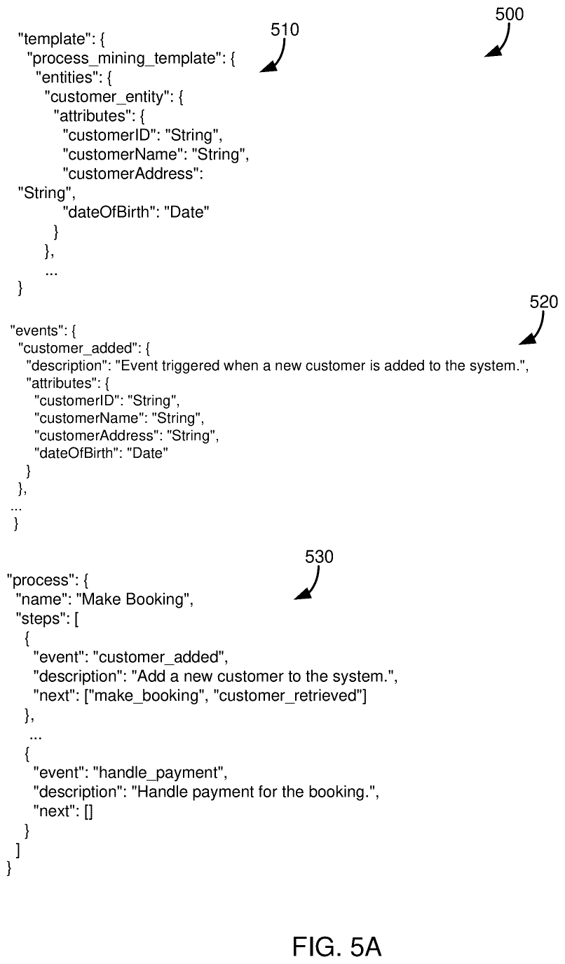

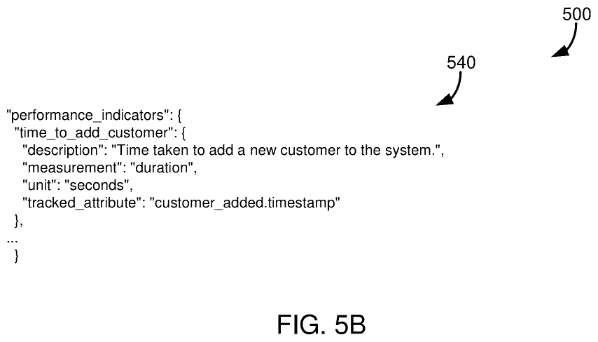

FIGS. 5A and 5B provides portions of code for an example template 500, in JSON format with keys and value datatypes, for a “make booking” process. The template 500 can include parts of the domain model and event domain model of the JSON listing although, in at least some implementations, the template includes only entities, relationships, and events that are relevant to a particular process (although, similar to the above discussion, templates that include all entities, relationships, and events for multiple processes can be defined, including for use in defining further templates that include a subset of components of the “complete” template. In this case, the template 500 includes code 510 defining a customer entity, where the full template would also include booking, ticket, seat, and payment entities.

FIG. 5A includes code 520 that defines events associated with the make booking process. Again, the events are those that are used in the make booking process, at least in some variants, and so may not include other events, such as “book act” which are more directly associated with a different process, which may have its own template.

Unlike the JSON listing 400 that focused on entities and events, the example template includes a process defined by code 530 of FIG. 5A. The code 530 specifies particular events, and a particular sequence in which the events occur. That is, the sequence can correspond to a main “expected” path in executing the process. In more complex cases, a template can specify process variants, such as including definitions similar to the code 530 for each variant, or by defining one or more primary process paths can then defining conditions where a different path may be taken, and subsequent events.

The JSON listing 500, in FIG. 5B, includes code 540 specifying various performance indicators. As with the domain model and domain element model, a process template can express elements at a more general level, and elements of the process template can be linked to other computer implementation artifacts that implement the relevant functionality. For example, a performance metric can be associated with an object in a virtual data model (such as a CDS view in technologies of SAP SE, of Walldorf, Germany). A virtual data model object can be mapped to various database objects, and can be used to retrieve data from such objects and perform relevant calculations to determine the performance metric.

Note that templates can be used by multiple entities, and a “master” or standard template updated based on any changes that the entities may make to the standard template. In the example process that has been described, an organization interested in promotions and querying their success will require additional data points from the system and, thus, will have to extend the domain model and the event domain model. The domain model will require a promotion object, while the event domain model must reflect the usage of such a promotion as part of the booking process. According to disclosed techniques, such modifications can be detected and analyzed for inclusion in a standard template, where the enhancements can then be used by other organizations.

In some cases, events can be added to a standard template when a sufficient number of entities have included the same modifications, such as defining a common event. Common events can be determined by, for example, determining whether queries associated with respective events are semantically equivalent. If the queries are semantically equivalent, the event can be determined to be a common event, even if the event has a different name or other characteristics.

### Example 3)—Example Data Extraction and Analysis

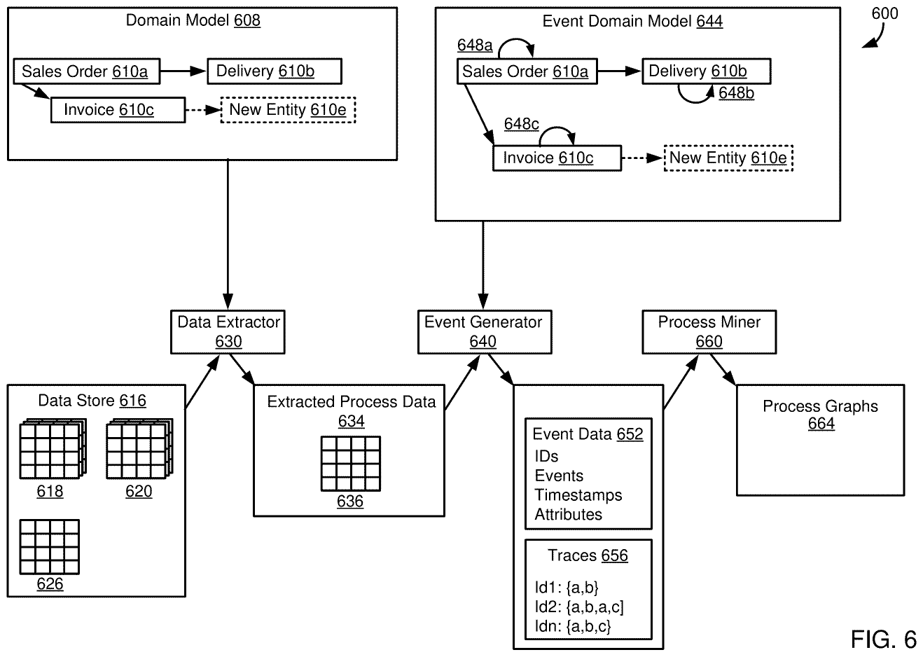

FIG. 6 illustrates an environment 600 that can be used to determine the occurrence of events in a process, including related computer implementation artifacts. The environment 600 includes a domain model 608. In this case, the domain model 608 represents a sales scenario with entities 610, shown as including a sales order entity 610a, a delivery entity 610b, and an invoice entity 610c. The domain model 608 can be similar to the domain model 100 of FIG. 1, in that attributes can be defined for the entities 610, and relationships can be defined between the entities.

The entities 610 are mapped to elements of a data store 616. The data store 616 can include standard tables 618 and, optionally, custom tables 620. Standard tables 618 can be tables that are provided with a base version of a software application, for which a standard process template (or a set of process templates, for various processes of the software application) are provided. The standard tables 618 can be modified to include custom columns for particular organizations, which again can be correlated with a domain model or other implementation artifacts.

The data store 616 can also include implementation artifacts that record data changes associated with the standard tables 618 or the custom tables 620. These implementation artifacts can include logs or change tables, where a change table 626 is illustrated in FIG. 6.

A data extractor 630 extracts data from the data store 616, such as from the change table 626. The data extractor 630 can be configured based on the domain model 608. For example, the data extractor 630 can be mapped to particular tables or particular columns of particular tables for the data store 616.

As an example, a simple domain model object/element can be represented as:

@ObjectModel: {
entityCustomer: {
name: ‘Customer’,
query: ‘ZCustomer View’
}
}

In this example, the “query” refers to an object in a virtual data model, such as a CDS view in technologies of SAP SE, of Walldorf, Germany. In turn, the CDS view can be defined as:

@AbapCatalog.sqlViewName: ‘ZCUSTOMER_VIEW’
@AbapCatalog.compiler.compareFilter: true
@AccessControl.authorizationCheck: #CHECK
@EndUserText.label: ‘Customer View’
define view ZCustomerView as select from knal as
Customer {
key Customer.Kunnr as CustomerID,
Customer.Name1 as FirstName,
Customer.Name2 as LastName,
Customer.Email
}

It can be seen that the view is mapped to a table, kna1, in the database, which has columns corresponding to the attributes (such as FirstName, LastName) of the view.

Extracted process data 634 can be associated with a defined structure, such as one or more tables 636. The one or more tables 636 can include table or table elements (such as table columns) that correspond to aspects of the customized domain model 608.

The extracted process data 634, including the one or more tables 636, can be processed by an event generator 640. The event generator 640 can identify the occurrence of events in the process specification, including those based on events of an event domain model 644. Like the domain model 608, the event domain model 644 can be modified to include new events, which can be based on added tables or columns of the data store 616, or which can be defined with respect to standard tables 618, but where the event definition differs from a “default” event definition associated with a template provided with the software application or a new event for entities included in such template.

The event domain model 644 is shown as including several standard events 648, such as an event 648a to create a sales order, an event 648b to create a delivery, and an event 648c to create an invoice. The events 648 can be associated with definitions as for the event domain model 300 of FIG. 3, and can be associated with queries to identify events in the extracted process data 634, such as described with respect to FIG. 3. The event generator 640 can provide data in an event table 652, which can include information such as an event identifier, an event type, an event timestamp, and event attributes. The event generator 640 can also produce traces 656. Traces 656 can represent particular paths, sequences of particular events, that were involved for a particular execution of the process.

A process miner 660 can use event data, such as information of the event table 652 or the traces 656 to provide process graphs 664. In some cases, a process graph 664 can represent all observed events, and sequences of events, that were observed in event information. A process graph 660 can provide information about the relative frequency of paths and their timing properties, as well as providing information regarding performance metrics associated with the process overall, as well as for particular process variants.

Performance metrics can be defined in a template, as described, and can be customized by particular organizations. In some implementations, performance metrics can be calculated in association with operations by the event generator 640 or by the process miner 660.

Information regarding processes can be analyzed and presented to organizations in a variety of ways, including to convey performance metrics and benchmark information. As a template is modified, and potentially a domain model or an event domain model, user interface controls can be added or modified, such as to alter a query that retrieves information from the data source 616, the event table 652, the traces 656, or information associated with the process graphs 660.

### Example 4)—Example User Interface for Process Mining Template Configuration

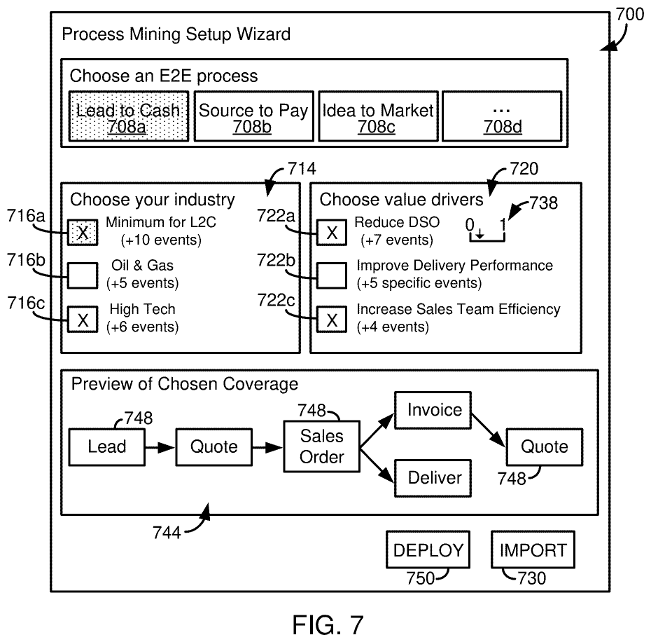

FIG. 7 illustrates an example user interface 700 that allows a user to set up a process mining project, including defining process mining parameters, and then deploying code that implements the corresponding process mining project.

A user can initially select a process 708, shown as processes 708a-708d, as a starting point. A selected process 708 includes a number of predefined components, such as events, relationships between events and entities, and queries that can be executed to determine whether an event has occurred. FIG. 7 illustrates that the Lead to Cash process 708a has been selected.

In a panel 714, a user is presented with information about their selected process, as well as information about additional customizations from which a user can select, which will cause associated events to be added to standard events for the process. For example, user interface element 716a indicates the selection of the Lead to Cash process, and that ten events are associated with the “base” process. User interface elements 716b and 716 are selectable by a user to add additional events to those of the base process, and display the corresponding number of events that will be added upon selection. The events associated with the user interface elements 716b and 716c correspond to specific industry areas in which the base process may be performed. As shown, user interface element 716c has been selected by the user, indicating that the process is being used in the high-tech industry, and that six additional events will be added to those of the base process.

Typically, process mining is performed to help an industry understand whether its processes are effective, and identify room for improvement. If a user is aware of a specific issue they would like to investigate, referred to here as a value driver, the user can select a user interface element 722a-722c in a panel 720 of the user interface. As shown, the user has selected user interface element 722a, to investigate the value driver of Days Sales Outstanding (DSO), associated with seven additional events, and user interface element 722c to investigate the value driver of Increase Sales Team Efficiency, associated with four additional events.

Once a user has made the selection of the industries and value drivers that are relevant to them, they can deploy a process mining template, or other representation of process mining definitions (more generally referred to as model information) based on these selections, and their associated events. The deployment can involve merging a template that includes information for mining the base process, one or more templates that include information for mining details of the base process that are relevant to selected industries, and one or more templates that include information for mining details of the base process that are relevant to selected value drivers. While described as being templates, components of templates can be maintained outside of a template, and used to populate a template based on user selections.

In some cases, it can be useful to provide users with information regarding how their particular processes or process mining procedures compare with peers or standards. By selecting an import user interface element 730, a user can select to import data to be analyzed for this purpose. Rather than analyzing all data for the entity associated with the user, a comparatively small portion of the data can be analyzed, such as using events of the selected process or events of customizations, or a larger set of events, to provide “preview” information to the user.

As shown in FIG. 7, a user interface element 738 provides an indication of how well the company associated with the user compares to other companies, in terms of performance with respect to a value driver. In particular, the user interface element 738 indicates that the entity performs poorly according to its peers. Among other things, this information can be used to help guide selections of the value drivers. That is, if the user is provided information that their DSO metrics are worse than peer companies, that may influence the user to select the user interface element 722a, since they have been alerted that this may be a problematic area for their company, and process mining may provide them with insights as to how performance may be improved.

The user interface 700 can also provide a preview 744 of the selected process, where the preview describes steps or events in the process and relationships between them. Individual elements 748 of the process can be provided with visual information indicating if any steps or events may be less performant than peer companies, or a comparison of an existing process defined for the entity, or detected in the processed sample data, with a standard process. For example, the individual elements can be highlighted, shading, or displayed in different colors to indicate relative performance or completeness. In FIG. 7, process elements 748 that are identified as lacking events corresponding to the template can be indicated by the use of darker shading. Again, this information can help guide a user as to what industry or value drivers should be selected to address definitional gaps in a process mining procedure or process performance gaps.

Once a user has selected their desired customization options, they can select to deploy a corresponding process mining template by selecting user interface element 750.

### Example 5)—Example Development and Selection of Event Clusters to Generate Model Information for Process Mining

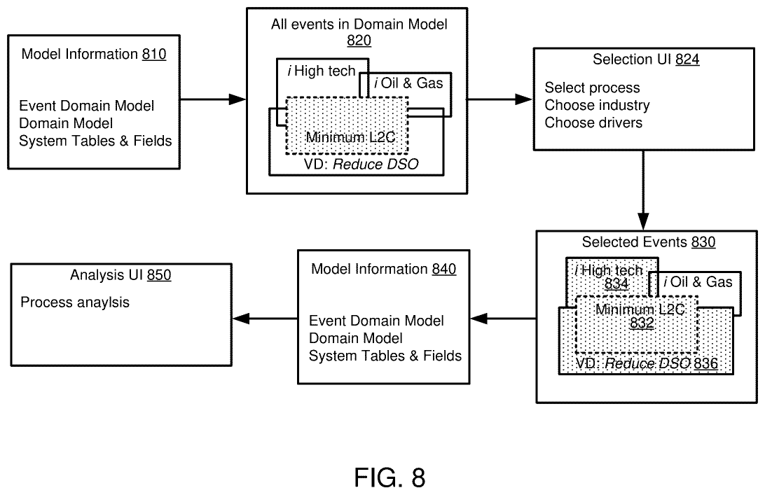

FIG. 8 provides a diagram illustrating events, and associated domain elements and database objects related to an event, can be determined, clustered, presented for user selection, deployed for use, and used in process analysis via mining.

In particular, model information 810 is obtained, which includes information about the event domain model, the domain model, and system fields and tables, as previously described. The model information 810 can be information in a template, or information that corresponds to information in a template. The model information 810 can be clustered or filtered in various ways. For example, events and related components (such as queries that look for an event) can be associated with tags indicating that they are associated with a particular process, industry, or value driver.

The events and associated information can then be clustered according to those tags. For example, analyzing the model information 810 can identify events that are common to a particular process, and thus included in a base set of events for the process. Some events may be present for a particular process in some industry fields, but not in others. The variability can result in industry-specific events not being included in a base model for the process, since they are not sufficiently common to specific implementations of the process.

However, an analysis similar to determining events to include in a base process model can be performed for particular industries or value drivers in a similar way. That is, if a certain event is sufficiently common among processes in a particular field, it can be added to a set of events defined to be standard events in that field. Similarly, if definitions of value drivers exhibit common events, those events can be included as standard events for the value drivers.

Clustering of the events in the model information 810 provides a set 820 of all events from the event model, or at least those that are sufficiently common such that they are defined as part of a base process, a specific industry within which the base process is used, or a particular value driver use to analyze the base process. A user can be provided with information about the set 820 in selection user interface 824 to select a particular process and particular industries and value drivers, such as the user interface 700.

The selections received through the user interface are used to narrow down elements of the set 820 that will be deployed to a set of selected events 830. As shown, the set 830 includes events 832 in the base Lead to Cash process, representing a minimum set of events for that process, as well as the events 834 defined for the high-tech industry and events 836 for the Reduce DSO value driver. A template incorporating the selected events is generated and deployed to a particular entity.

Model information 840 can be generated based on the selected events, typically having a proper subset of events in the overall model information 810. The model information 840 can be used in implementing process mining, where process mining results can be displayed in an analysis user interface 850. The analysis user interface 850 can provide various representations of process model information. In some cases, the user interface can display a graphical representation of the process, including providing metrics, such as key performance indicators, with regards to events or steps in a process.

In addition, or alternatively, the user interface 850 can include widgets, a type of user interface element, that can display information from the process mining results, including the data used to generate the graphical representation in a more readily understandable format. As the term is used in the present disclosure, a widget is a self-contained, interactive component or module that displays specific information, performs a particular function, or provides user interaction capabilities. Widgets can serve as building blocks of the interface, each focusing on a distinct aspect of the process mining data, such as visualizations, metrics, filters, or controls.

A widget is typically designed to be modular and configurable, allowing users to customize their interface by selecting, resizing, or rearranging widgets to suit their specific needs. For example, in a process mining dashboard, a widget might display a process flow diagram, highlight key performance indicators such as cycle time or throughput, present a histogram of process variants, or provide interactive filters for narrowing the scope of analysis. Each widget is designed to operate independently but often integrates with others to contribute to a cohesive and comprehensive user experience.

In some implementations, widgets are correlated with specific events. Thus, making a selection of events to include in a process model can result in deployment of only widgets that are relevant for the events in the process model.

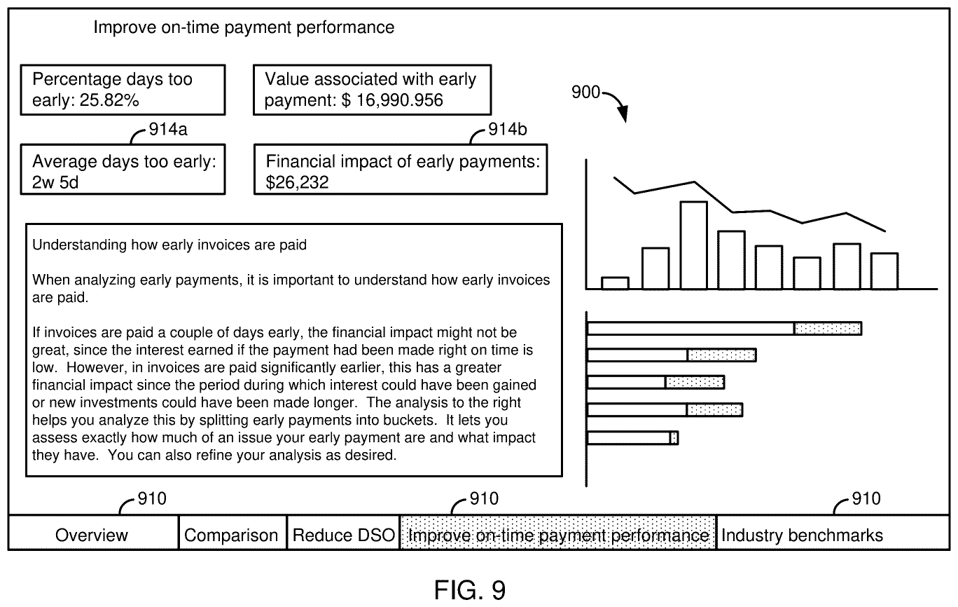

FIG. 9 provides an example user interface 900, which can be a particular implementation of the analysis user interface 850 of FIG. 8. The user interface 900 includes tabs 910 that can be used to view data, and corresponding widgets 914, for particular purposes, such as an overview of a process, a comparison with industry benchmarks, or information relating to a particular value driver, such as one selected when defining a process mining model to be deployed (such as using the selection user interface 824). As noted, widgets 914 can be associated with particular events or sets of events, and thus the widgets presented in the user interface 900 for a selected tab 910. Since each tab 910 may be associated with different events, the user interface 900 for each tab may have different widgets 914.

As examples of information that can be presented using the widgets 914, a widget 914a can display information such as a time between two events, where the time is relevant to a particular performance metric or value driver. A widget 914b can provide information regarding a monetary value associated with documents (which in turn are generated using data stored in a database, including data generated as part of processing mining) related to the events, including with respect to a particular time period over which the process was monitored. As another example of how time-based information can be provided, a widget 914 displays a graph of “clearing” events over time, which can provide, for example, an indication of whether there is significant deviation in a number of clear events for particular time segments in the time period. If so, it may suggest to a user that the reasons for such variability be further investigated, to help understand how the variability can be reduced, and potentially increase a number or rate of clearing events.

Widgets can be provided as part of standard process mining content, including providing widgets that are part of a template. Users may be permitted to modify provided widgets, as well as to add new widgets. Widgets have a definition that can be processed by a computer, including having a definition that specifies its metadata, such as the widget's name, description, and associated events. This metadata helps in identifying the widget and understanding its purpose.

Widget implementation includes data binding, where the data sources and the data binding logic are specified. This involves defining the queries or data retrieval mechanisms that will populate the widget with relevant data. For example, a widget displaying the time between two events would have queries to fetch timestamps of those events. A user can, for example, change what data sources are used with the widget.

In addition to customizing widgets based on data sources, users can customize queries associated with widgets, such as those that retrieve data to be processed or displayed using the widget. Users can select specific events that the widget should monitor, based on predefined templates or custom queries defined by the user. This selection process allows users to tailor the widget to their specific needs. Additionally, parameterization enables users to filter data dynamically, such as filtering events based on a date range or specific attributes. Thus, a widget may have a definition and logic that allows it to be used with different events, and a user can change what events are associated with a particular widget.

The visual appearance of a widget can be customized. For example, a user can choose from different types of visualizations, such as bar charts, line graphs, or pie charts, based on the data and the insights they wish to derive. Users can also customize the appearance of the widget, including colors, labels, and legends, to align the widget with their branding or visual preferences. Interaction design can also be customized, such as by including user interface elements that allow users to click on elements within the widget to drill down into more detailed data. For instance, clicking on a bar in a bar chart could show a detailed breakdown of the data represented by that bar. Additionally, widgets can be designed to update dynamically based on real-time data changes, ensuring that the insights provided are always current.

Widgets can be shared between entities. This can be achieved through export and import functionality, where users can export the widget's configuration, including metadata, queries, and visualization settings, into a standardized format such as JSON or XML. Other users can then import the exported configuration into their system. A centralized repository of widget templates can be maintained, allowing users to browse and select from both standard templates and user-contributed customizations. Implementing version control for widget templates helps track changes and updates, allowing users to use a specific version of a widget or update to the latest version as needed.

The technical implementation of customizing and sharing widgets involves several components and technologies. Backend services include data retrieval APIs to fetch data from various sources based on the queries defined in the widget configuration, and storage services to save and manage widget configurations, including metadata, queries, and visualization settings. Frontend components include a configuration user interface for defining and customizing widgets, and visualization libraries such as D3.js or Chart.js to render the customized widgets based on the configuration.

In the context of the process mining template discussed in the present disclosure, widgets can be part of the template and can be customized and shared similarly to events. Customized templates can be monitored, and if enough users make similar widget changes or additions, these customizations can be incorporated into a standard template. This approach allows the most useful and commonly used customizations are made available to all users, enhancing the overall utility and effectiveness of the process mining templates.

The templates can facilitate the creation or customization of widgets by non-technical users, such as those in business positions. The templates have high-level concepts, such as a process and actions in the process, that are mapped to low-level technical implementation details. This mapping makes it easier for nontechnical users to customize widgets without needing to understand the underlying complexities. For example, a user might select a high-level business metric they are interested in, such as “Reduce Days Sales Outstanding (DSO),” and the system will automatically configure the necessary data bindings, queries, and visualizations to support this metric. This abstraction layer allows users to focus on their business needs while the system handles the technical details.

### Example 6)—Example Operations

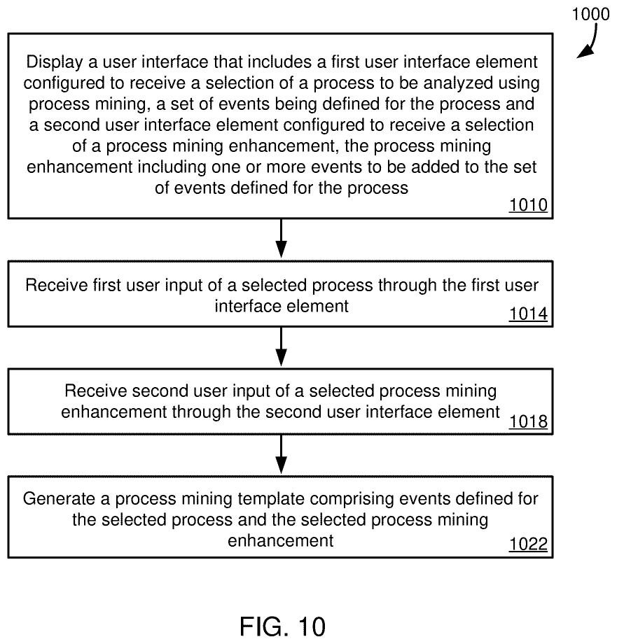

FIG. 10 provides a flowchart of a process 1000 of configuring a process mining template that includes events for process mining enhancements. At 1010, a user interface is displayed. The user interface includes a first user interface element configured to receive a selection of a process to be analyzed using process mining, with a set of events being defined for the process. At 1014, a second user interface element is displayed. The second user interface element is configured to receive a selection of a process mining enhancement, the process mining enhancement including one or more events to be added to the set of events defined for the process.

First user input of a selected process is received through the first user interface element at 1018. At 1022, second user input of a selected process mining enhancement is received through the second user interface element. A process mining template is generated at 1026. The process mining template includes events defined for the selected process and the selected process mining enhancement.

### Example 7)—Additional Examples

Example 1 is a computing system that includes at least one memory, one or more hardware processing units coupled to the at least one memory, and one or more computer-readable storage media storing computer-executable instructions. The instructions, when executed, cause the computing system to perform operations. The operations include displaying a user interface that includes a first user interface element configured to receive a selection of a process to be analyzed using process mining, with a set of events being defined for the process, and a second user interface element configured to receive a selection of a process mining enhancement, the process mining enhancement including one or more events to be added to the set of events defined for the process. First user input of a selected process is received through the first user interface element. Second user input of a selected process mining enhancement is received through the second user interface element. A process mining template is generated, including events defined for the selected process and the selected process mining enhancement.

Example 2 is the computing system of Example 1, where the process mining enhancement is a specific industry in which the process will be used.

Example 3 is the computing system of Example 1, where the process mining enhancement is a value driver.

Example 4 is the computing system of any of Examples 1-3, the operations further including deploying the process mining template and analyzing execution of the process using the process mining template.

Example 5 is the computing system of Example 4, the operations further including generating a user interface displaying results analyzing execution of the process using the process mining template, the user interface including a user interface element, such as a widget, that processes data associated with an event of the process mining template.

Example 6 is the computing system of Example 5, the operations further including receiving a customization of the user interface element, where the user interface element is defined in the process mining template, determining that a plurality of entities have performed a similar customization of the user interface element, and adding the customized user interface element to a standard process mining template for the process or the process mining enhancement.

Example 7 is the computing system of any of Examples 1-6, the operations further including determining events for a plurality of processes, clustering events from the plurality of processes by process or process mining enhancement to provide clusters of events, and displaying indicators of at least a portion of the clusters of events in the user interface.

Example 8 is the computing system of any of Examples 1-7, the operations further including obtaining a sample of process data for an entity, analyzing the sample of process data using events of the process, comparing performance metrics determined from the events to standard performance metrics, and displaying on the user interface results of the comparing performance metrics.

Example 9 is the computing system of any of Examples 1-8, the operations further including obtaining a sample of process data for an entity, analyzing the sample of process data using events of the process, comparing events determined from analyzing the sample of process data to events of the process or the process mining enhancement, and displaying on the user interface an indication of events of the process or process mining enhancement that are or are not present in the sample of process data.

Example 10 is the computing system of any of Examples 1-9, where events of the events include a query to be executed by a database system to determine occurrences of the events.

Example 11 is a method, implemented in a computing system that includes at least one memory and at least one hardware processing unit coupled to the at least one memory. The method includes displaying a user interface that includes a first user interface element configured to receive a selection of a process to be analyzed using process mining, with a set of events being defined for the process, and a second user interface element configured to receive a selection of a process mining enhancement, the process mining enhancement including one or more events to be added to the set of events defined for the process. First user input of a selected process is received through the first user interface element. Second user input of a selected process mining enhancement is received through the second user interface element. A process mining template is generated, including events defined for the selected process and the selected process mining enhancement.

Example 12 is the method of Example 11, the operations further including deploying the process mining template, analyzing execution of the process using the process mining template, generating a user interface displaying results analyzing execution of the process using the process mining template, the user interface including a user interface element that processes data associated with an event of the process mining template. The operations further include receiving a customization of the user interface element, where the user interface element is defined in the process mining template, determining that a plurality of entities have performed a similar customization of the user interface element, and adding the customized user interface element to a standard process mining template for the process or the process mining enhancement.

Example 13 is the method of Example 11 or Example 12, further including determining events for a plurality of processes, clustering events from the plurality of processes by process or process mining enhancement to provide clusters of events, and displaying indicators of at least a portion of the clusters of events in the user interface.

Example 14 is the method of any of Examples 11-13, further including obtaining a sample of process data for an entity, analyzing the sample of process data using events of the process, comparing events determined from analyzing the sample of process data to events of the process or the process mining enhancement, and displaying on the user interface an indication of events of the process or process mining enhancement that are or are not present in the sample of process data.

Example 15 is the method of any of Examples 11-14, where the process mining enhancement is a specific industry in which the process will be used or a value driver.

Example 16 is one or more non-transitory computer-readable storage media including computer-executable instructions that, when executed by a computing system that includes at least one hardware processor and at least one memory coupled to the at least one hardware processor, cause the computing system to perform various operations. The operations include displaying a user interface that includes a first user interface element configured to receive a selection of a process to be analyzed using process mining, with a set of events being defined for the process, and a second user interface element configured to receive a selection of a process mining enhancement. The process mining enhancement includes one or more events to be added to the set of events defined for the process. The operations further include receiving first user input of a selected process through the first user interface element. Second user input is received of a selected process mining enhancement through the second user interface element. A process mining template is generated that includes events defined for the selected process and the selected process mining enhancement.

Example 17 is the one or more non-transitory computer-readable storage media of Example 16, where the operations further include deploying the process mining template, analyzing execution of the process using the process mining template, and generating a user interface displaying results analyzing execution of the process using the process mining template. The user interface includes a user interface element that processes data associated with an event of the process mining template. A customization of the user interface element is received, where the user interface element is defined in the process mining template. It is determined that a plurality of entities have performed a similar customization of the user interface element, and the customized user interface element is added to a standard process mining template for the process or the process mining enhancement.

Example 18 is the one or more non-transitory computer-readable storage media of Example 16 or Example 17, further including determining events for a plurality of processes, clustering events from the plurality of processes by process or process mining enhancement to provide clusters of events, and displaying indicators of at least a portion of the clusters of events in the user interface.

Example 19 is the one or more non-transitory computer-readable storage media of any of Examples 16-18, further including operations of obtaining a sample of process data for an entity, analyzing the sample of process data using events of the process, comparing events determined from analyzing the sample of process data to events of the process or the process mining enhancement, and displaying on the user interface an indication of events of the process or process mining enhancement that are or are not present in the sample of process data.

Example 20 is the one or more non-transitory computer-readable storage media of any of Examples 16-19, where the process mining enhancement is a specific industry in which the process will be used or a value driver.

### Example 8—Computing Systems

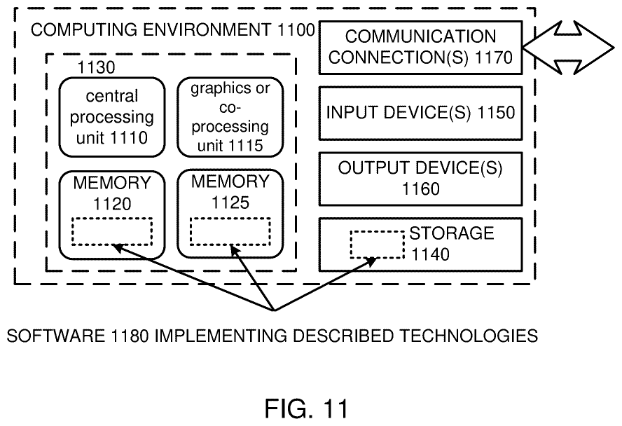

FIG. 11 depicts a generalized example of a suitable computing system 1100 in which the described innovations may be implemented. The computing system 1100 is not intended to suggest any limitation as to scope of use or functionality of the present disclosure, as the innovations may be implemented in diverse general-purpose or special-purpose computing systems.

With reference to FIG. 11, the computing system 1100 includes one or more processing units 1110, 1115 and memory 1120, 1125. In FIG. 11, this basic configuration 1130 is included within a dashed line. The processing units 1110, 1115 execute computer-executable instructions, such as for implementing technologies described in Examples 1-7. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 11 shows a central processing unit 1110 as well as a graphics processing unit or co-processing unit 1115. The tangible memory 1120, 1125 may be volatile memory (e.g., registers, cache, RAM), non-volatile memory (e.g., ROM, EEPROM, flash memory, etc.), or some combination of the two, accessible by the processing unit(s) 1110, 1115. The memory 1120, 1125 stores software 1180 implementing one or more innovations described herein, in the form of computer-executable instructions suitable for execution by the processing unit(s) 1110, 1115.

A computing system 1100 may have additional features. For example, the computing system 1100 includes storage 1140, one or more input devices 1150, one or more output devices 1160, and one or more communication connections 1170. An interconnection mechanism (not shown) such as a bus, controller, or network interconnects the components of the computing system 1100. Typically, operating system software (not shown) provides an operating environment for other software executing in the computing system 1100, and coordinates activities of the components of the computing system 1100.

The tangible storage 1140 may be removable or non-removable, and includes magnetic disks, magnetic tapes or cassettes, CD-ROMs, DVDs, or any other medium which can be used to store information in a non-transitory way, and which can be accessed within the computing system 1100. The storage 1140 stores instructions for the software 1180 implementing one or more innovations described herein.

The input device(s) 1150 may be a touch input device such as a keyboard, mouse, pen, or trackball, a voice input device, a scanning device, or another device that provides input to the computing system 1100. The output device(s) 1160 may be a display, printer, speaker, CD-writer, or another device that provides output from the computing system 1100.

The communication connection(s) 1170 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules or components include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

In various examples described herein, a module (e.g., component or engine) can be “coded” to perform certain operations or provide certain functionality, indicating that computer-executable instructions for the module can be executed to perform such operations, cause such operations to be performed, or to otherwise provide such functionality. Although functionality described with respect to a software component, module, or engine can be carried out as a discrete software unit (e.g., program, function, class method), it need not be implemented as a discrete unit. That is, the functionality can be incorporated into a larger or more general-purpose program, such as one or more lines of code in a larger or general-purpose program.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 9—Cloud Computing Environment

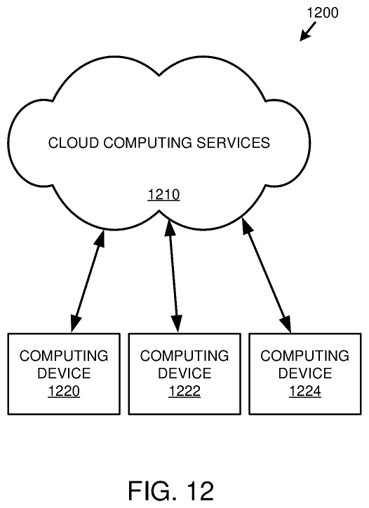

FIG. 12 depicts an example cloud computing environment 1200 in which the described technologies can be implemented. The cloud computing environment 1200 comprises cloud computing services 1210. The cloud computing services 1210 can comprise various types of cloud computing resources, such as computer servers, data storage repositories, networking resources, etc. The cloud computing services 1210 can be centrally located (e.g., provided by a data center of a business or organization) or distributed (e.g., provided by various computing resources located at different locations, such as different data centers and/or located in different cities or countries).

The cloud computing services 1210 are utilized by various types of computing devices (e.g., client computing devices), such as computing devices 1220, 1222, and 1224. For example, the computing devices (e.g., 1220, 1222, and 1224) can be computers (e.g., desktop or laptop computers), mobile devices (e.g., tablet computers or smart phones), or other types of computing devices. For example, the computing devices (e.g., 1220, 1222, and 1224) can utilize the cloud computing services 1210 to perform computing operators (e.g., data processing, data storage, and the like).

### Example 10—Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media, such as tangible, non-transitory computer-readable storage media, and executed on a computing device (e.g., any available computing device, including smart phones or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example, and with reference to FIG. 11, computer-readable storage media include memory 1120 and 1125, and storage 1140. The term computer-readable storage media does not include signals and carrier waves. In addition, the term computer-readable storage media does not include communication connections (e.g., 1170).

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C, C++, C#, Java, Perl, JavaScript, Python, R, Ruby, ABAP, SQL, XCode, GO, Adobe Flash, or any other suitable programming language, or, in some examples, markup languages such as html or XML, or combinations of suitable programming languages and markup languages. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present, or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computing system comprising:
at least one memory;
one or more hardware processing units coupled to the at least one memory; and
one or more computer readable storage media storing computer-executable instructions that, when executed, cause the computing system to perform operations comprising:
displaying a user interface comprising:
a first user interface element configured to receive a selection of a process to be analyzed using process mining, a set of events being defined for the process; and
a second user interface element configured to receive a selection of a process mining enhancement, the process mining enhancement comprising one or more events to be added to the set of events defined for the process;
receiving first user input of a selected process through the first user interface element;
receiving second user input of a selected process mining enhancement through the second user interface element; and
generating a process mining template comprising events defined for the selected process and the selected process mining enhancement.

2. The computing system of claim 1, wherein the process mining enhancement is a specific industry in which the process will be used.

3. The computing system of claim 1, wherein the process mining enhancement is a value driver.

4. The computing system of claim 1, the operations further comprising:
deploying the process mining template; and
analyzing execution of the process using the process mining template.

5. The computing system of claim 4, the operations further comprising:
generating a user interface displaying results analyzing execution of the process using the process mining template, the user interface comprising a user interface element that processes data associated with an event of the process mining template.

6. The computing system of claim 5, the operations further comprising:
receiving a customization of the user interface element, wherein the user interface element is defined in the process mining template;
determining that a plurality of entities have performed a similar customization of the user interface element; and
adding the customized user interface element to a standard process mining template for the process or the process mining enhancement.

7. The computing system of claim 1, the operations further comprising:
determining events for a plurality of processes; and
clustering events from the plurality of process by process or process mining enhancement to provide clusters of events; and
displaying indicators of a least a portion of the clusters of events in the user interface.

8. The computing system of claim 1, the operations further comprising:
obtaining a sample of process data for an entity;
analyzing the sample of process data using events of the process;
comparing performance metrics determined from the events to standard performance metrics; and
displaying on the user interface results of the comparing performance metrics.

9. The computing system of claim 1, the operations further comprising:
obtaining a sample of process data for an entity;
analyzing the sample of process data using events of the process;
comparing events determined from the analyzing the sample of process data to events of the process or the process mining enhancement; and
displaying on the user interface an indication of events of the process or process mining enhancement that are or are not present in the sample of process data.

10. The computing system of claim 1, wherein events of the events comprise a query to be executed by a database system to determine occurrences of the events.

11. A method, implemented in a computing system comprising at least one memory and at least one hardware processing unit coupled to the at least one memory, the method comprising:
displaying a user interface comprising:
a first user interface element configured to receive a selection of a process to be analyzed using process mining, a set of events being defined for the process; and
a second user interface element configured to receive a selection of a process mining enhancement, the process mining enhancement comprising one or more events to be added to the set of events defined for the process;
receiving first user input of a selected process through the first user interface element;
receiving second user input of a selected process mining enhancement through the second user interface element; and
generating a process mining template comprising events defined for the selected process and the selected process mining enhancement.

12. The method of claim 11, the operations further comprising:
deploying the process mining template;
analyzing execution of the process using the process mining template;
generating a user interface displaying results analyzing execution of the process using the process mining template, the user interface comprising a user interface element that processes data associated with an event of the process mining template;
receiving a customization of the user interface element, wherein the user interface element is defined in the process mining template;
determining that a plurality of entities have performed a similar customization of the user interface element; and
adding the customized user interface element to a standard process mining template for the process or the process mining enhancement.

13. The method of claim 11, further comprising:
determining events for a plurality of processes;
clustering events from the plurality of process by process or process mining enhancement to provide clusters of events; and
displaying indicators of a least a portion of the clusters of events in the user interface.

14. The method of claim 11, further comprising:
obtaining a sample of process data for an entity;
analyzing the sample of process data using events of the process;
comparing events determined from the analyzing the sample of process data to events of the process or the process mining enhancement; and
displaying on the user interface an indication of events of the process or process mining enhancement that are or are not present in the sample of process data.

15. The method of claim 11, wherein the process mining enhancement is a specific industry in which the process will be used or a value driver.

16. One or more non-transitory computer-readable storage media comprising:
computer-executable instructions that, when executed by a computing system comprising at least one hardware processor and at least one memory coupled to the at least one hardware processor, cause the computing system to display a user interface comprising:
a first user interface element configured to receive a selection of a process to be analyzed using process mining, a set of events being defined for the process; and
a second user interface element configured to receive a selection of a process mining enhancement, the process mining enhancement comprising one or more events to be added to the set of events defined for the process;
computer-executable instructions that, when executed by the computing system, cause the computing system to receive first user input of a selected process through the first user interface element;
computer-executable instructions that, when executed by the computing system, cause the computing system to receive second user input of a selected process mining enhancement through the second user interface element; and
computer-executable instructions that, when executed by the computing system, cause the computing system to generate a process mining template comprising events defined for the selected process and the selected process mining enhancement.

17. The one or more non-transitory computer-readable storage media of claim 16, the operations further comprising:
computer-executable instructions that, when executed by the computing system, cause the computing system to deploy the process mining template;
computer-executable instructions that, when executed by the computing system, cause the computing system to analyze execution of the process using the process mining template;
computer-executable instructions that, when executed by the computing system, cause the computing system to generate a user interface displaying results analyzing execution of the process using the process mining template, the user interface comprising a user interface element that processes data associated with an event of the process mining template;
computer-executable instructions that, when executed by the computing system, cause the computing system to receive a customization of the user interface element, wherein the user interface element is defined in the process mining template;
computer-executable instructions that, when executed by the computing system, cause the computing system to determine that a plurality of entities have performed a similar customization of the user interface element; and
computer-executable instructions that, when executed by the computing system, cause the computing system to add the customized user interface element to a standard process mining template for the process or the process mining enhancement.

18. The one or more non-transitory computer-readable storage media of claim 16, further comprising:
computer-executable instructions that, when executed by the computing system, cause the computing system to determine events for a plurality of processes;
computer-executable instructions that, when executed by the computing system, cause the computing system to cluster events from the plurality of process by process or process mining enhancement to provide clusters of events; and
computer-executable instructions that, when executed by the computing system, cause the computing system to display indicators of a least a portion of the clusters of events in the user interface.

19. The one or more non-transitory computer-readable storage media of claim 16, further comprising:
computer-executable instructions that, when executed by the computing system, cause the computing system to obtain a sample of process data for an entity;
computer-executable instructions that, when executed by the computing system, cause the computing system to analyze the sample of process data using events of the process;
computer-executable instructions that, when executed by the computing system, cause the computing system to compare events determined from the analyzing the sample of process data to events of the process or the process mining enhancement; and
computer-executable instructions that, when executed by the computing system, cause the computing system to display on the user interface an indication of events of the process or process mining enhancement that are or are not present in the sample of process data.

20. The one or more non-transitory computer-readable storage media of claim 16, wherein the process mining enhancement is a specific industry in which the process will be used or a value driver.
